(19) United States
(12) Patent Application Publication
(10) Pub. No.: US 2008/0020165 A1
(43) Pub. Date: Jan. 24, 2008

(54) Tamper evident label

(75) Inventor: William Drori, Hampstead (CA)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: Sandora Sales and Manufacturing Ltd.

(21) Appl. No.: 11/637,923

(22) Filed: Dec. 13, 2006

Related U.S. Application Data
(60) Provisional application No. 60/750,409, filed on Dec. 15, 2005.

(51) Int. Cl. B32B 33/00

(52) U.S. Cl. 428/40.1

(57) ABSTRACT

A tamper evident label is provided for securing objects such as shipping packages or the like. The label, which is applicable on the closure of the object, leaves a warning message on the object if it is removed therefrom, even if the label is first frozen or heated. The tamper evident label includes successively a flexible film top layer; a release agent layer forming a predetermined pattern defining a first tamper evident message; a first ink layer with ink releasable upon removal of the label from the object; a second ink layer defining a second tamper evident message with irreversible thermochromic ink; an adhesive layer resistant to freezing temperature conditions; and a removable liner. A process for making such a label is also provided.

### FIELD OF THE INVENTION

The present invention relates to the field of packaging accessories, and more particularly concerns a label for shipping packages or the like providing evidence of tampering.

### BACKGROUND OF THE INVENTION

Security of packages, envelopes or any other containers used for shipping goods or documents is a major concern in a lot of circumstances, such as the forwarding of legal or sensitive documents, biological products, medical supplies, etc. A variety of solutions exist to prevent or at least detect that a package has been tampered with in transit. Such solutions include tapes or labels which are applied on the package and leave a visible mark if someone tries to remove them. The recipient of the package can therefore immediately see if someone has tried to open the package before it has reached its destination.

Such tamper evident labels must still serve their purpose no matter the technique used by potential interceptors to circumvent their use, for example by freezing or heating the label, or with the use of specific chemical products.

Freezing is usually accomplished by inverting an aerosol can and spraying the propellant on the label. The propellant freezes the adhesive on the label, making it temporarily ineffective. This tampering technique has been used successfully with prior art labels, and is especially effective within the twenty-four hours following the application of the label; once frozen, it can be easily removed without leaving any signs of tampering.

Another way to gain entry to a protected package is to heat up the adhesive on the label to a point where it softens; this again allows the label to be removed without leaving any trace of having been there.

While solutions are known to address some of these tampering techniques, there is still a need for a label product which would address all of them simultaneously.

### OBJECT AND SUMMARY OF THE INVENTION

It is an object of the present invention to provide a tamper evident label for an envelope, package or the like, which leaves a warning message on the package if it is removed therefrom, even if the label is first frozen or heated.

In accordance with a first aspect of the invention, there is provided a tamper evident label applicable on a closure of an object so that removal therefrom leaves thereon evidence of tampering. The label includes, successively:
a flexible film top layer;
a release agent layer forming a predetermined pattern, the predetermined pattern defining a first tamper evident message;
a first ink layer covering at least the predetermined pattern. Ink of the first ink layer contacts the predetermined pattern and is releasable upon removal of the label from the object;
a second ink layer defining a second tamper evident message. Ink of the second ink layer includes an irreversible thermochromic ink;
an adhesive layer including an adhesive resistant to freezing temperature conditions; and
a removable liner protecting the label prior to the application thereof to the closure of the object.

In accordance with a second aspect of the present invention, there is also provided a process for making a tamper evident label, this label being applicable on a closure of an object so that removal therefrom leaves thereon evidence of tampering. The process includes the following steps successively:
providing a flexible film top layer having a front and a rear surface;
inscribing a predetermined pattern defining a first tamper evident message on the rear surface of the flexible film layer, using a release agent;
covering the rear surface of the flexible film layer with a first ink layer, the first ink layer contacting at least the predetermined pattern being releasable upon removal of the label from the object;
applying a second ink layer defining a second tamper evident message over the first ink layer, the second ink layer including an irreversible thermochromic ink;
laminating the rear surface of the flexible film to a removable liner, the liner having an adhesive layer thereon placed contiguously to the rear surface of the flexible film layer. The adhesive layer includes an adhesive resistant to freezing temperature conditions;
cooling the laminated film;
winding the laminated film into a master roll;
printing information on the front surface of the flexible film layer; and
separating the flexible film layer into individual pieces, each piece defining a tamper evident label.

In accordance with a third aspect of the invention, there is provided a tamper evident label applicable on a closure of an object so that removal therefrom leaves thereon evidence of tampering. The label includes, successively:
a flexible film top layer having a thickness ranging from about 18 to about 50 μm;
between about 4.5 and about 6.5 Billion Cubic Microns (BCM) of a release agent layer forming a predetermined pattern, the predetermined pattern defining a first tamper evident message;
between about 1.2 and about 4.5 BCM of a first ink layer covering at least the predetermined pattern. Ink of the first ink layer contacts the predetermined pattern and is releasable upon removal of the label from the object;
between about 7.5 and about 15 BCM of a second ink layer defining a second tamper evident message. Ink of the second ink layer includes an irreversible thermochromic ink;
between about 20 and about 38 g/m² of an adhesive layer comprising an adhesive resistant to freezing temperature conditions; and
a removable liner protecting the label prior to the application thereof to the closure of the object, the removable liner having a thickness ranging from about 25 to about 776 μm.

Other features and advantages of the present invention will be better understood upon reading of a preferred embodiment thereof with reference to the appended drawings.

### BRIEF DESCRIPTION OF THE DRAWINGS

FIG. 1 is a cross-sectional side view of a tamper evident label according to a preferred embodiment of the invention.

FIG. 2 is a perspective view of a label according to a preferred embodiment of the invention applied on a package to be secured and showing a warning message indicating that the label is a tamper evident label, printed on the front surface of the flexible film.

FIG. 3 is a perspective view of a label according to a preferred embodiment of the invention showing a tamper evident message that appeared on the package upon removal of the label after it has been frozen or heated.

FIG. 4 is a flowchart showing the successive steps of a process used to manufacture a tamper evident label according to a preferred embodiment of the invention.

### DESCRIPTION OF PREFERRED EMBODIMENTS OF THE INVENTION

In accordance with a preferred embodiment of the invention, there is provided a tamper evident label to be applied to an object to secure the content thereof.

It will be understood that the object to be secured may be any sort of package, including but not limited to paper or plastic envelopes, plastic or metal containers, cardboard box, corrugated cartons or the like.

In practice, once a package is closed, a label according to the present invention is applied over the sealed area; this allows validating that the package has not been opened by anyone between the time the sender sealed it and the recipient receives it. As the package is transferred from one party to the next, each intermediary along the way can verify that the label does not show any indication of tampering. If the tamper evident indicator on the package is undamaged, then it can be assumed that the content has not been altered or viewed since it was sealed in the package.

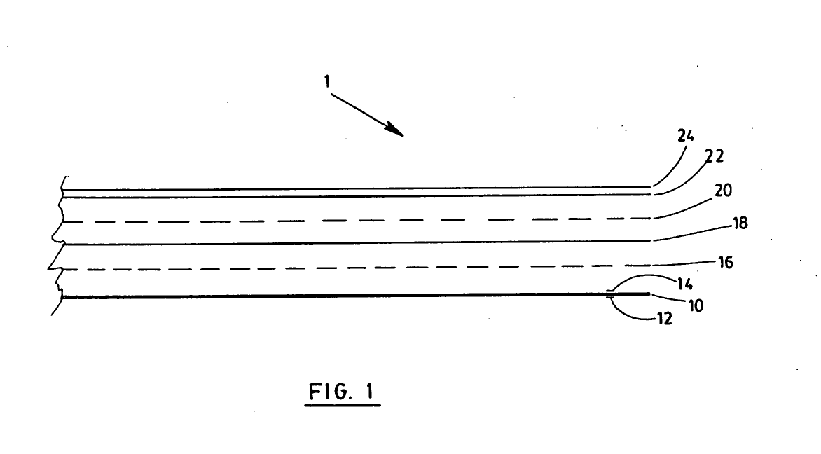

Referring to FIG. 1, there is shown a cross-sectional representation of the different layers of a label (1) according to a preferred embodiment of the invention.

The label (1) first includes a flexible film layer (10), having a front surface (12) and a rear surface (14). The flexible film layer is preferably made of a polypropylene, an acetate or a polystyrene film of an appropriate thickness, which may for example be comprised between about 18 and about 50 μm, and more preferably of the order of 30 μm.

Optionally, the flexible film layer (10) may be provided with a plurality of cuts on its front surface (12), i.e. the surface which is visible when the label is placed on the closure of a package. The cuts are specially designed so that the label tears up upon removal thereof from the package, providing an additional security measure, even against tampering by heat.

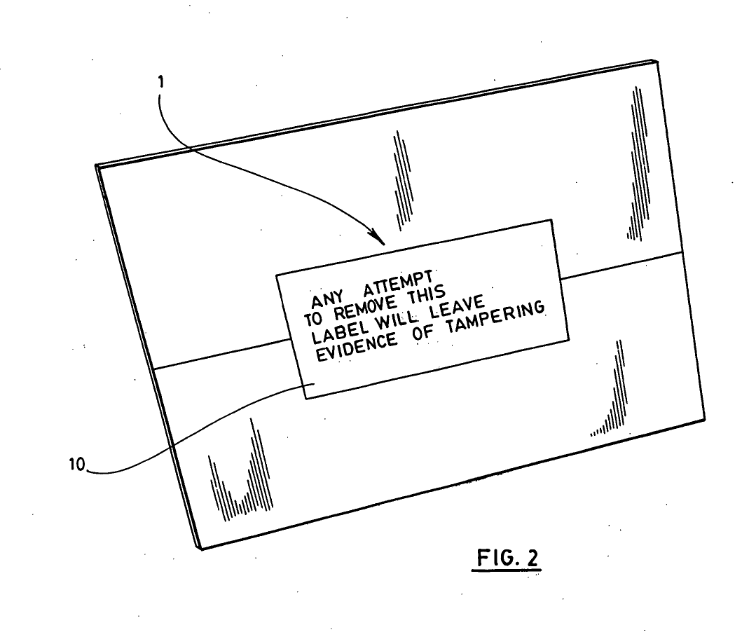

The front surface (12) of the flexible film may also be provided with printed information. The printed information may be embodied by any appropriate written or graphic message such as a company name or logo, a decorative pattern, or simply a warning message to indicate that the label is a tamper evident label and that any attempt to remove thereof will leave evidence of tampering (FIG. 2).

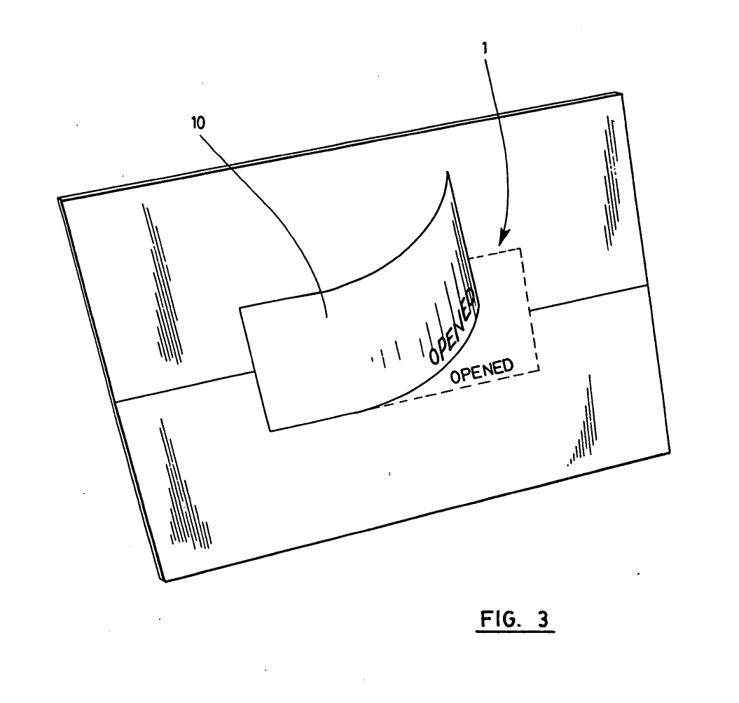

The next two layers on the rear surface (14) of the flexible film layer (10) provide tampering evidence when the label is removed from the closure of the object, even if the label is frozen prior to the removal attempt (FIG. 3). The first of these two layers, which is directly in contact with the rear surface (14) of the flexible film layer (10) consists of a release agent layer (16) forming a predetermined pattern which defines a first tamper evident message. The tamper evident message can be any warning word, message or image or a specially designed graphic. For example, the warning message can simply be the word “OPENED” (FIG. 3). In a preferred embodiment, the release agent includes an aliphatic hydrocarbon based solution. It can be for example the L-230 Varnish ‘safe’™ commercialized by ROTOFLEX® AG Grenchen, Switzerland or the UV silicone release varnish #14714E commercialized by Northwest Coatings, USA. The volume of release agent present in the label must be controlled as it can affect the label's effectiveness. Indeed, too much release agent would cause a separation between the first ink layer and the flexible film when the liner protecting the label prior to its use is removed, while insufficient release agent will not leave the desired message when frozen. In the preferred embodiment, the volume of the release agent layer (16) is preferably between about 4.5 and about 6.5 BCM (Billion Cubic Microns).

Over the release agent layer (16) is a first ink layer (18) which covers at least the pattern left by the release agent. In the preferred embodiment, the first ink layer (18) uniformly covers the entire release agent layer (16). More preferably, the ink of this first ink layer is a dark coloured ink or full tint ink. The darker the colour, the greater the contrast when the warning message appears. If an attempt is made to remove the label, only the portions of the dark coloured ink layer in contact with the release agent is left behind on the package, thus releasing the warning message formed by the pattern (FIG. 3). If the first ink layer covers the entire surface of the film, the warning message will also appear, in negative, on the surface of the label which has been torn off. In the preferred embodiment, the volume of the first ink layer is preferably between about 1.2 and about 4.5 BCM.

If heat is applied to the label in an attempt to remove it from the package, the release agent may not be effective to leave the first tamper evident message behind. Thus, the next layer of the label provides for tampering evidence if the label is heated prior to removal. This layer consists of a second ink layer (20) which defines a second tamper evident message formed with an irreversible thermochromic ink. An adhesive layer (22) is provided over this second ink layer (20), as will be detailed further below. The irreversible thermochromic ink consists of a heat indicator solution of encapsulated permanent dyes. The encapsulated dyes are released at a temperature at which the adhesive layer substantially softens, which is above about 70° C. for the adhesive used in the preferred embodiment of the invention, and will not fade or revert to their original state. The volume of the heat indicator solution is controlled to ensure the appropriate reaction; with an insufficient amount, the reaction will take too long to occur, while an excessive amount will cause the reaction to occur too early. Preferably, the volume of the thermochromic ink layer is between about 7.5 and about 15 BCM. Then, if heat is applied to the flexible film surface of the label, in an attempt to soften the adhesive to gain entry to a protected package, the encapsulations of the heat indicator layer rupture, thereby releasing the permanent dyes and leaving the warning message (FIG. 3). An example of an appropriate heat indicator solution is the Indicating Ink TIT-FWC-152 commercialized by Tempil Inc., USA. As already mentioned above, the tamper evident message can be any warning word, message or image or a specially designed graphic. The first and the second tamper evident messages can be identical or different. More preferably, they are different.

The adhesive layer (22) which is above the heat indicator layer not only allows the label to be glued to the object to be secured, but also provides a further security against tampering if an attempt is made to remove the label upon freezing thereof prior to its removal. Indeed, according to the preferred embodiment, the adhesive layer (22) is made of an adhesive which is resistant to freezing temperature conditions, for example for temperatures of about −50° C. Preferably, a specifically selected hot melt adhesive is formulated to be particularly resistant to low temperature conditions, while having an extremely high initial tack value, for example of the order of 458.4 cm³/cm² (100 ounces/square inch). The weight of the adhesive layer is also preferably controlled in order to ensure that the label adheres to packaging surfaces such as cardboard, and is preferably comprised between about 20 and about 38 g/m² of the total label surface. Even more preferably, the weight is of the order of 35 g/m². An example of an appropriate hot melt adhesive is DURO-TAK™ 34.764B commercialized by Nacan® Products Limited, Canada. Thus, the presence of such a hot melt adhesive in the label, together with a proper thickness of release agent as explained above, allows to the warning indication to appear when the label is removed from the package, even if the label is first frozen in attempt of tampering.

Finally, the last layer of the label which is in contact with the adhesive layer (22) is a removable liner (24). The liner is used to protect the label prior to its application to the closure of the package. Preferably, the liner is made of silicone, without any retention additive at all, and its thickness ranges from about 25 to about 776 μm.

In accordance with another aspect of the invention, there is provided a process for making a tamper evident label of the type described above.

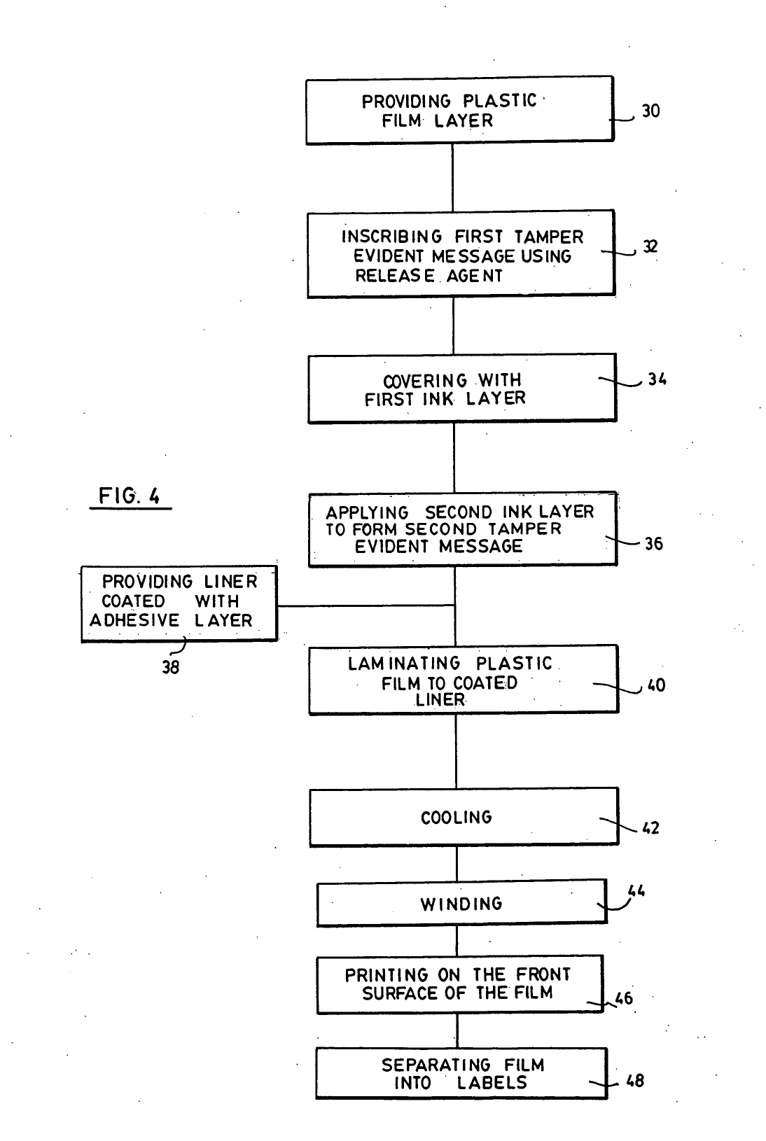

Referring to FIG. 4, there is shown a flowchart representing the different steps of the process used to produce the label according to a preferred embodiment of the invention.

A flexible film layer, for example a 30 μm thick propylene film, is provided (30) and inserted through a press wherein a predetermined pattern of a release agent layer is inscribed (32) on the rear surface of the film. The release agent preferably includes an aliphatic hydrocarbon based solution. The volume of release agent is closely controlled as it is directly related to the effectiveness of the label. Preferably, the solution of the release agent is applied using an anilox supplying at least 4.5 BCM (Billion Cubic Microns) and not more than 6.5 Bcm of the solution.

The rear surface of the film may be then corona treated, for example to 38-44 dyne, before arriving at the next printing station. At this station, the optionally corona treated rear surface of the flexible film layer is covered (34) by a first ink layer, which preferably consists of a dark coloured ink. This dark coloured ink layer covers at least the predetermined pattern left by the release agent. Preferably, it covers the entire surface of the flexible film.

The next station along the press applies (36) a second ink layer defining a second tamper evident message over the first ink layer. This second ink layer, used as a heat indicator, includes an irreversible thermochromic ink which preferably consists of encapsulated permanent dyes. The volume of the heat indicator solution should be closely controlled to ensure the appropriate reaction, i.e. the rupture of the encapsulations and the release of the permanent dyes if the label is heated up.

At this point, a removable liner (24) coated with an adhesive layer, the adhesive thereof being resistant to freezing temperature conditions, is brought (38) into the production line. The removable liner preferably consists of a silicone web.

Next, the rear surface of the flexible film is laminated (40) to the removable coated liner and the laminated film is cooled (42) to stabilize all reactions.

The laminated film is then wound (44) into a master roll and processed to another press where a further information is printed (46) on its front surface, for example a warning message indicating “ANY ATTEMPT TO REMOVE THIS LABEL WILL LEAVE EVIDENCE OF TAMPERING” as seen in FIG. 3, or the like. Then, the film is separated (48) into individual pieces, each defining a tamper evident label. The liner may further be cut in two to make its removal from the remainder of the label easier. According to another preferred embodiment the labels are sequentially numbered, thereby making each label unique.

As being now better appreciated, the present invention is an improvement and presents several advantages over other related devices and/or methods known in the prior art. Indeed, the present invention is particularly advantageous in that it provides a tamper evident label capable of securing shipping packages or the like against tampering even if the label is frozen or heated prior to removal attempts.

Of course, numerous modifications could be made to the above-described embodiments without departing from the scope of the invention, as apparent to a person skilled in the art. While a specific embodiment of the present invention has been described and illustrated, it will be apparent to those skilled in the art that numerous modifications and variations can be made without departing from the scope of the invention as defined in the appended claims.

1- A tamper evident label applicable on a closure of an object so that removal therefrom leaves thereon evidence of tampering, said label comprising, successively:
a flexible film top layer;
a release agent layer forming a predetermined pattern, said predetermined pattern defining a first tamper evident message;
a first ink layer covering at least said predetermined pattern, ink of said first ink layer contacting said predetermined pattern being releasable upon removal of the label from the object;
a second ink layer defining a second tamper evident message, ink of said second ink layer comprising an irreversible thermochromic ink;
an adhesive layer comprising an adhesive resistant to freezing temperature conditions; and
a removable liner protecting said label prior to the application thereof to the closure of said object.

2- The tamper evident label as claimed in claim 1, wherein said flexible film is selected from the group consisting of a polypropylene film, an acetate film and a polystyrene film.

3- The tamper evident label as claimed in claim 2, wherein said film has a thickness of about 30 μm.

4- The tamper evident label as claimed in claim 1, wherein said release agent comprises an aliphatic hydrocarbon based solution.

5- The tamper evident label as claimed in claim 1, wherein the ink of said first ink layer is a dark coloured ink having a volume ranging from about 1.2 to about 4.5 BCM.

6- The tamper evident label as claimed in claim 1, wherein the irreversible thermochromic ink of said second ink layer consists of a solution of encapsulated permanent dyes.

7- The tamper evident label as claimed in claim 6, wherein said permanent dyes are releasable at a temperature above a threshold temperature at which said adhesive substantially softens.

8- The tamper evident label as claimed in claim 7, wherein the threshold temperature is about 70° C.

9- The tamper evident label as claimed in claim 1, wherein the irreversible thermochromic ink has a volume ranging from about 7.5 to about 15 BCM.

10- The tamper evident label as claimed in claim 1, wherein the adhesive has a weight ranging from about 20 to 38 g/m² of a total surface of the label.

11- The tamper evident label as claimed in claim 1, wherein said removable liner has a thickness ranging from about 25 to about 776 μm.

12- The tamper evident label as claimed in claim 1, wherein said flexible film layer is provided with a plurality of cuts therein, said cuts being designed so that the label tears up upon removal thereof from the object.

13- A process for making a tamper evident label, said label being applicable on a closure of an object so that removal therefrom leaves thereon evidence of tampering, said process comprising the following steps successively:
providing a flexible film top layer having a front and a rear surface;
inscribing a predetermined pattern defining a first tamper evident message on the rear surface of said flexible film layer, using a release agent;
covering said rear surface of the flexible film layer with a first ink layer, said first ink layer contacting at least said predetermined pattern being releasable upon removal of the label from the object;
applying a second ink layer defining a second tamper evident message over said first ink layer, said second ink layer comprising an irreversible thermochromic ink;
laminating the rear surface of the flexible film to a removable liner, said liner having an adhesive layer thereon placed contiguously to said rear surface of the flexible film layer, said adhesive layer comprising an adhesive resistant to freezing temperature conditions;
cooling the laminated film;
winding the laminated film into a master roll;
printing information on the front surface of said flexible film layer; and
separating said flexible film layer into individual pieces, each defining a tamper evident label.

14- The process as claimed in claim 13, wherein the rear surface of the flexible film layer is corona treated prior to be covered by the first ink layer.

15- The process as claimed in claim 14, wherein said flexible film layer is selected from the group consisting of a polypropylene film, an acetate film and a polystyrene film.

16- The process as claimed in claim 15, wherein said film has a thickness of about 30 μm.

17- The process as claimed in claim 13, wherein said release agent comprises an aliphatic hydrocarbon based solution.

18- The process as claimed in claim 13, wherein the ink of said first ink layer is a dark coloured ink.

19- The process as claimed in claim 13, wherein the ink of said second ink layer consists of a solution of encapsulated permanent dyes.

20- A tamper evident label applicable on a closure of an object so that removal therefrom leaves thereon evidence of tampering, said label comprising, successively:
a flexible film top layer having a thickness ranging from about 18 to about 50 μm;
between about 4.5 and about 6.5 Billion Cubic Microns (BCM) of a release agent layer forming a predetermined pattern, said predetermined pattern defining a first tamper evident message;
between about 1.2 and about 4.5 BCM of a first ink layer covering at least said predetermined pattern, ink of said first ink layer contacting said predetermined pattern being releasable upon removal of the label from the object;
between about 7.5 and about 15 BCM of a second ink layer defining a second tamper evident message, ink of said second ink layer comprising an irreversible thermochromic ink;
between about 20 and about 38 g/m² of an adhesive layer comprising an adhesive resistant to freezing temperature conditions; and
a removable liner protecting said label prior to the application thereof to the closure of said object, said removable liner having a thickness ranging from about 25 to about 776 μm.
